(19) United States
(12) Patent Application Publication
(10) Pub. No.: US 2014/0063036 A1
(43) Pub. Date: Mar. 6, 2014

(54) Image Processing Method and Display System Thereof

(71) Applicant: NOVATEK Microelectronics Corp., Hsin-Chu (TW)

(72) Inventors: Huan-Yu Lin, Kaohsiung City (TW); Kuei-Chung Chang, Hsinchu County (TW); Tzung-Yuan Lee, Taichung City (TW)

(73) Assignee: NOVATEK Microelectronics Corp., Hsin-Chu (TW)

(21) Appl. No.: 13/964,111

(22) Filed: Aug. 12, 2013

(30) Foreign Application Priority Data
Sep. 6, 2012 (TW) 101132556

(51) Int. Cl. G06T 5/00

(52) U.S. Cl. CPC G06T 5/00
USPC 345/581

(57) ABSTRACT

An image processing method for an image processing device is disclosed. The image processing method includes receiving a setting value and a display data; calculating and converting a plurality of input pixel values of the display data according to the setting value, to obtain a plurality of target output pixel values of the display data; and adjusting a plurality of output pixel values of the display data to the plurality of target output pixel values in a plurality of frames gradually.

### BACKGROUND OF THE INVENTION

1. Field of the Invention

The present invention relates an image processing method and a display system thereof, and more particularly, to an image processing method and a display system thereof capable of adjusting a switching step level and a number of frames for each switch, to change a display image to a target image gradually and slowly.

2. Description of the Prior Art

In general, image processing circuits modify content of an initial display data through changing setting values of related parameters for image processing and calculating accordingly, to show the effect of image processing (such as edge sharpening, color enhancement, imaging contrast raising etc.) on a display panel immediately in the next display image (i.e. the next frame) for satisfying visual sense of users.

However, the general display data displays the same display image continuously or display image which is changed gradually (i.e. the display images are mostly the same between serial frames). The conventional image processing circuit processes the display data and then shows the display image in the next frame immediately. Besides, the conventional image processing circuit stops processing the display data and then shows the display image without image processing in the next frame immediately. Therefore, when (1) the image processing is disabled→the image processing is enabled; (2) the image processing is enabled→the image processing is disabled; (3)the setting value of the parameter is A→the setting value of parameter is B wherein A and B are different values, the same pixel in the display image between the serial frames can show a great difference. It causes the display image changing significantly and makes human eyes feel unsmooth or uncomfortable. Thus, there is a need for improvement of the prior art.

### SUMMARY OF THE INVENTION

It is therefore an objective of the claimed invention to provide an image processing method and a display system thereof which is able to design the switching step level and the number of frames to change display image the target image gradually and slowly.

The present invention discloses an image processing method for an image processing device. The image processing method includes receiving a setting value and a display data; calculating and converting a plurality of input pixel values of the display data according to the setting value, to obtain a plurality of target output pixel values of the display data; and adjusting a plurality of output pixel values of the display data to the plurality of target output pixel values in a plurality of frames gradually.

This present invention further discloses a display system. The display system includes a host device for transmitting a setting value and a display data; an image processing device for receiving the setting value and the display data and; calculating and converting a plurality of input pixel values of the display data according to the setting value, to obtain a plurality of target output pixel values of the display data; and adjusting a plurality of output pixel values of the display data to the plurality of target output pixel values in a plurality of frames gradually; and a display device for displaying the image according to a plurality of output pixel values of the display data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a display system according to an embodiment of the present invention.

FIG. 2 illustrates input-output curves for the image processing device in FIG. 1.

FIG. 3 illustrates a flow chart of an image processing to an embodiment of the present invention.

### DETAILED DESCRIPTION

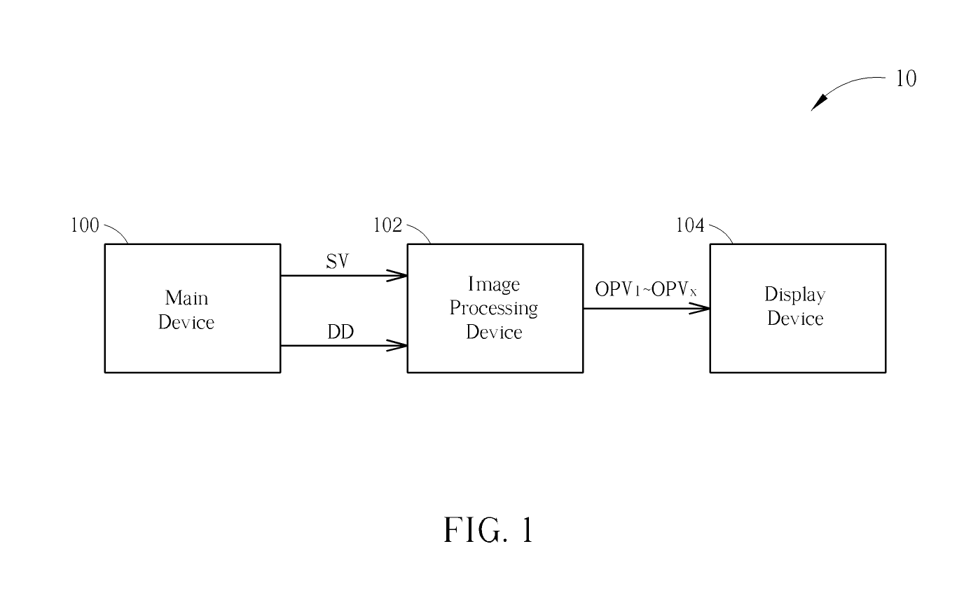

Please refer to FIG. 1, which illustrates a display system 10 according to an embodiment of the present invention. As shown in FIG. 1, the display system 10 includes a host device 100, an image processing device 102 and a display device 104. In short, the host device 100 transmits a setting value SV and a display data DD to the image processing device 102. After receiving the setting value SV and the display data DD, the image processing device 102 calculates and converts input pixel values IPV₁˜IPVₓ of the display data DD according to the setting value SV, to obtain target output pixel values TOPV₁˜TOPVₓ of the display data DD. The image processing device 102 adjusts output pixel values OPV₁˜OPVₓ of the display data DD outputted to the display device 104 to the target output pixel values TOPV₁˜TOPVₓ in the frames F₁˜F_{y} gradually. However, please note that the present invention is not limited to adjustment of “gray level” of pixel. In the practical application, the present invention can adjust chroma value or other parameters, such as another value of color coordinate, i.e. the pixels value can be any presentation manner of color gamut or any special format accepted by the display device. Such variation is also belonged to the scope of the present invention.

Then, the display device 104 displays the image according to the output pixel values OPV₁˜OPVₓ outputted by the image processing device 102. As a result, the image processing device 102 can adjust the output pixel values OPV₁˜OPVₓ of the display data DD to the target output pixel values TOPV₁˜TOPVₓ by a specific switching step level in a specific number of frames according the practical requirement. Therefore, the display device 104 can change the display image to the target image gradually and slowly according to the output pixel values OPV₁˜OPVₓ.

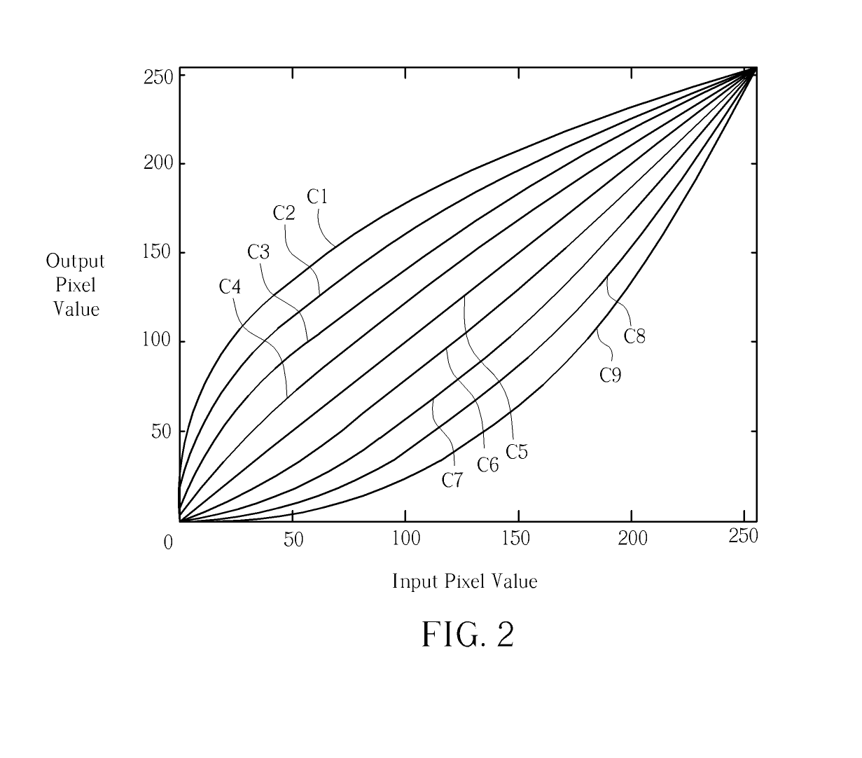

In detail, please refer to FIG. 2, which illustrates input-output curves C1˜C9 used by the image processing device 102 in FIG. 1, wherein the curve C5 is the setting value for disabling the image processing. As shown in FIG. 2, since different setting values SV are corresponding to the different input-output curves among the input-output curves C1˜C9, the image processing device 102 can calculate and convert the input pixel values IPV₁˜IPVₓ of the display data DD according a target input-output curve among the input-output curves C1˜C9 which is corresponding to the setting value SV (i.e. a specific mapping relation between input pixel values and output pixel values), to obtain the target output pixel values TOPV₁˜TOPVₓ of the display data DD.

In such a situation, compared with the conventional image processing circuit which processes the display data and displays the processed display data in the next frame immediately such that the display image in the same pixel of the data is changed significantly (e.g. the output pixel value is changed significantly when the input-output curve switches form the input-output curve C1 to the input-output curve C7), the image processing device 102 of the present invention can design the switching step level and the number of frames for each switch, to adjust the output pixel values OPV₁˜OPVₓ of display data to the target output pixel values TOPV₁˜TOPVₓ gradually and slowly.

Specifically, in an embodiment of a curve-based dimming, the image processing device 102 calculates and converts the input pixel values IPV₁˜IPVₓ of the display data DD gradually according to a plurality of adjusting input-output curves from an initial input-output curve to the target input-output curve, to adjust the output pixel values OPV₁˜OPVₓ of the display data DD to the target output pixel values TOPV₁˜TOPVₓ in the frames F₁˜F_{y} gradually. In other words, the image processing device 102 switch at least one input-output curve among the plurality of adjusting input-output curves every one or more than one frames. In such a situation, the image processing device 102 can perform the adjustment to any alterations of setting value SV.

For example, when the setting is switching an input-output curve every two frames, if (1) the image processing is switched from disable (i.e. the initial input-output curve C5) to enable and the setting value SV is corresponding to the target input-output curve C2, the image processing device 102 can switch the input-output curve in the an order of C5→C4→C4→C3→C3→C2 in the frames F₁˜F₅(one frame for each switch), to adjust the output pixel values OPV₁˜OPVₓ of the display data DD to the target output pixel values TOPV₁˜TOPVₓ in frames F₁˜F₅ gradually; else if (2) the image processing is switched from enable to disable (i.e. the target input-output curve C5) and the initial setting value SV is corresponding to the initial input-output curve C9, the image processing device 102 can switch the input-output curve in an order of C9→C8→C8→C7→C7→C6→C6→C5 in the frames F₁˜F₇ (two frames for each switch), to adjust the output pixel values OPV₁˜OPVₓ of the display data DD to the target output pixel values TOPV₁˜TOPVₓ in the frames F₁˜F₇ gradually; else if (3) the image processing is switch from the initial setting value SV which is corresponding to input-output curve C3 to the setting value SV which is corresponding to the target input-output curve C7, the image processing device 102 can switch the input-output curve in an order of C3→C4→C4→C5→C5→C6→C6→C7 in the frames F₁˜F₇, to adjust the output pixel values OPV₁˜OPVₓ of the display data DD to the target output pixel values TOPV₁˜TOPVₓ in the frames F₁˜F₇ gradually.

Besides, in the embodiment of the fixed-time-based dimming, the image processing device 102 can divide each of difference values between the target output pixel values TOPV₁˜TOPVₓ value and the output pixel values OPV₁˜OPVₓ to a plurality of equal values and change the output pixel values OPV₁˜OPVₓ of the display data DD by a fixed value for every switch in the plurality of fixed values in the frames F₁˜F_{y} gradually, to adjust the output pixel values OPV₁˜OPVₓ of the display data DD to the target output pixel values TOPV₁˜TOPVₓ in the frames F₁˜F_{y} gradually. In other words, the image processing device 102 can add the equal value in the plurality of equal values to the output pixel values OPV₁˜OPVₓ of the display data DD every one or more than one frames. In such a situation, the image processing device 102 can finish the switch in the predefined fixed number of frames to display the image.

For example, when the setting is switch for every two frames and completing the adjustment in four switches and the pixel values before and after image processing are RGB and R′G′B′ respectively, if (1) the image processing is switched from disable to enable, taking the output pixel value R is switched to the target pixel value R′ and the absolute value of the difference between the pixel value R′ and the pixel value R is D for example, the image processing 102 can switch the pixel value in an order of R→R+(D*1/4)→R+(D*1/4)→R+(D*2/4)→R+(D*2/4)→R+(D*3/4)→R+(D*3/4)→R′ (in the situation that the pixel value R is less than pixel value R′), or the order of R→R−(D*1/4)→R−(D*1/4)→R−(D*2/4)→R−(D*2/4)→R−(D*3/4)→R−(D*3/4)→R′ (in the situation that the pixel value R is greater than pixel value R′) in the frames F₁˜F₇; else if (2) the image processing is switched from enable to disable, taking the output pixel value and the target pixel value are R and R′, respectively and the absolute value of the difference between the pixel value R′ and the pixel value R is D for example, the image processing 102 can switch the pixel value in an order of R′→R′−(D*1/4)→R′−(D*1/4)→R′−(D*2/4)→R′−(D*2/4)→R′−(D*3/4)→R′−(D*3/4)→R (in the situation that the pixel value R is less than pixel value R′), or the order of R′→R′+(D*1/4)→R′+(D*1/4)→R′+(D*2/4)→R′+(D*2/4)→R′+(D*3/4)→R′+(D*3/4)→R (in the situation that the pixel value R is greater than pixel value R′) in the frames F₁˜F₇.

Noticeably, the spirit of the present invention is to design the switching step level and the number of frames for each switch according to the practical requirement, to adjust the output pixel values OPV₁˜OPVₓ to the target output values TOPV₁˜TOPVₓ gradually and slowly. Therefore, the display image can be changed to the target image according to the output pixel values OPV₁˜OPVₓ gradually and slowly. Those skilled in the art can make modification and alterations accordingly. For example, the present invention changes the display data DD and does not change the dimming mechanism of backlight. Therefore, the present invention can be applied to any display devices. Besides, the interface of transmitting the setting value SV and the display data DD between the main device 100 to the image processing device 102 can be wired or wireless transmission. Moreover, the image processing 102 can be an independent device or a slave device belongs to the main device 100 and the display device 104 can be a device which is able to convert the electrical signal of the output pixel values OPV₁˜OPVₓ to the visible wavelength and makes the content of the signal can be sensed by human eyes.

In addition, in the above-mentioned embodiment, the curve-based dimming switches the input-output curves sequentially. The pixel-value-based dimming changes the pixel values by two and the fixed-time-based dimming switches four times to complete the adjustment. However, in other embodiments, the switching step level and the number of frames for each switch can be adjusted according the practical requirement and the image processing 102 can include a first register for setting the switching step level (a number of the input-output curves for each switch, a number of the pixel values for each switch, the number of switching times to finish the adjustment), a second register for setting the specific number of frames for each switch and a controlled circuit for switching and controlling the manner of dimming, to realize the above-mentioned embodiment.

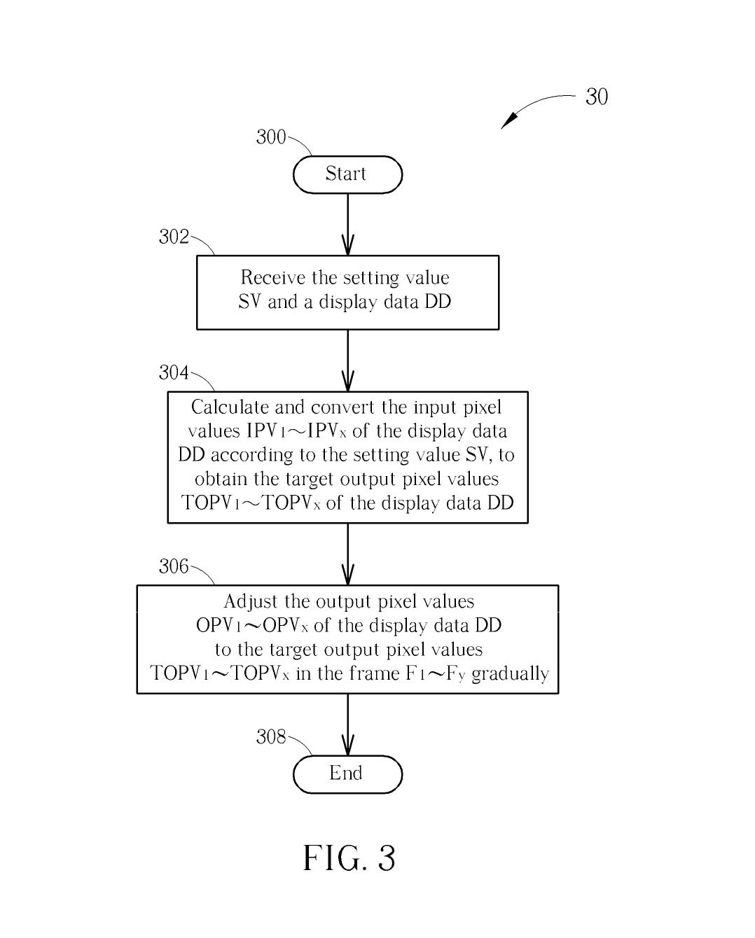

Therefore, the image processing operation of the image processing device 102 can be summarized into an image processing process 30 as shown in FIG. 3. The image processing process 30 includes following steps:

Step 300: Start.

Step 302: Receive the setting value SV and the display data DD.

Step 304: Calculate and convert the input pixel values IPV₁˜IPVₓ of the display data DD according to the setting value SV, to obtain the target output pixel values TOPV₁˜TOPVₓ of the display data DD.

Step 306: Adjust the output pixel values OPV₁˜OPVₓ of the display data DD to the target output pixel values TOPV₁˜TOPVₓ in the frames F₁˜F_{y} gradually.

Step 308: End.

Details of the image processing process 30 can be derived by referring to the above related description of the image processing device 102, and are not narrated hereinafter.

In the prior art, general display data displays the same display image continuously or display image which is changed gradually (i.e. the display images are mostly the same between the serial frames). The conventional image processing circuit processes the display data and then shows the display image in the next frame immediately. Besides, the conventional image processing circuit stops processing the display data and then shows the display image without process in the next frame immediately. Therefore, the same pixel in the display image between the serial frames can show a great difference. It causes the display image changing significantly and makes the human eyes feel unsmooth or uncomfortable. In comparison, the present invention can design the switching step level and the number of frames for each switch according to the practical requirement, to adjust the output pixel values OPV₁˜OPVₓ to the target output pixel values TOPV₁˜TOPVₓ. Therefore, the display image can be changed to the target image gradually and slowly according the output pixel values OPV₁˜OPVₓ.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method for an image processing device, comprising:
receiving a setting value and display data;
calculating and converting a plurality of input pixel values of the display data according to the setting value, to obtain a plurality of target output pixel values of the display data; and
adjusting a plurality of output pixel values of the display data to the plurality of target output pixel values in a plurality of frames gradually.

2. The image processing method of claim 1, wherein the setting value is corresponding to a target input-output curve among a plurality of input-output curves, and the step of calculating and converting the plurality of input pixel values of the display data according to the setting value, to obtain the plurality of target output pixel values of the display data comprises:
calculating and converting the plurality of input pixel values of the display data according to the target input-output curve, to obtain the plurality of target output pixel values of the display data.

3. The image processing method of claim 2, wherein the step of adjusting the plurality of output pixel values of the display data to the plurality of target output pixel values in the plurality of frames gradually comprises:
calculating and converting the plurality of input pixel values of the display data in the plurality of frames gradually according to a plurality of adjusting input-output curves form an initial input-output curve to the target input-output curve, to adjust the plurality of output pixel values of the display data to the plurality of target output pixel values in the plurality of frames gradually.

4. The image processing method of claim 3, wherein the step of calculating and converting the plurality of input pixel values of the display data in the plurality of frames gradually according to the initial input-output curve to the target input-output curve comprises:
switching at least one adjusting input-output curve among the plurality of adjusting input-output curve every one or more than one frames in the plurality of frames.

5. The image processing method of claim 1, wherein the step of adjusting the plurality of output pixel values of the display data to the plurality of target output pixel values of the display data in the plurality of frames gradually comprising:
changing the plurality of output pixel values of the display data by a fixed pixel values every time in the plurality of frames gradually, to adjust the plurality of output pixel values of the display data to the plurality of target output pixel values in the plurality of frames gradually.

6. The image processing method of claim 5, wherein the step of changing the plurality of output pixel values of the display data by the fixed pixel values every time in the plurality of frames gradually, to adjust the plurality of output pixel values of the display data to a plurality of target output pixel values in the plurality of frames comprising:
changing the plurality of output pixel values of the display data by fixed pixel values every one or more than one frames in the plurality of frames.

7. The image processing method of claim 1, wherein the step of adjusting the plurality of output values of the display data to the plurality of target output pixels values in the plurality of frames gradually comprises:
dividing each of difference values between the plurality of target output pixel values and the plurality of output pixel values into a plurality of equal values; and
changing the plurality of output pixel values of the display data by one of the plurality of equal values in the plurality of frames gradually, to adjust the plurality of output pixel values of the display data to the plurality of target output pixel values in the plurality of frames gradually.

8. The image processing method of claim 7, wherein the step of adjusting the plurality output pixel values of the display data to the plurality of target output pixel values in the plurality of frames gradually comprises:
changing the plurality of output pixel values of the display data by one of the plurality of equal values gradually every one or more than one frames in the plurality of frames.

9. The image processing method of claim 1, wherein the pixel value is a presentation manner of color gamut or a special format accepted by the display device.

10. The image processing method of claim 1, wherein the pixel value is a gray level or a chroma value.

11. A display system, comprising:
a host device, for transmitting a setting value and a display data;
an image processing device, for receiving the setting value and the display data, calculating and converting a plurality of input pixel values of the display data according to the setting value, to obtain a plurality of target output pixel values of the display data, adjusting a plurality of output pixel values of the display data to the plurality of target output pixel values in a plurality of frames gradually; and
a display, for displaying according to a plurality of output pixel values of the display data.

12. The display system of claim 11, wherein the setting value is corresponding to a target input-output curve among a plurality of input-output curves and the image processing device calculates and converts the plurality of input pixel values of the display data according to the target input-output curve, to obtain the plurality of target output pixel values of the display data.

13. The display system of claim 12, wherein the image processing device calculates and converts the plurality of input pixel values of the display data in the plurality of frames gradually according to a plurality of adjusting input-output curves form an initial input-output curve to the target input-output curve, to adjust the plurality of output pixel values of the display data to the plurality of target output pixel values in the plurality of frames gradually.

14. The display system of claim 13, wherein the image processing device switches the input-output curves among the plurality of adjusting input-output curve by one or more than one terms every one or more than one frames in the plurality of frames.

15. The display system of claim 11, wherein the image processing device changes the plurality of output pixel values of the display data
by a fixed pixel value every time in the plurality gradually, to adjust the plurality of output pixel values of the display data to the plurality of target output pixel values in the plurality of frames gradually.

16. The display system of claim 15, wherein the image processing device changes the plurality of output pixel values of the display data by fixed pixel values every one or more than one frames in the plurality of frames.

17. The display system of claim 11, wherein the image processing device divides each of difference values between the plurality of target output pixel values and the plurality of output pixel values to a plurality of equal values and changes each of the plurality of output pixel values of the display data by one of the plurality of equal values in the plurality of frames gradually, to adjust the plurality of output pixel values of the display data to the plurality of target output pixel values in the plurality of frames gradually.

18. The display device of claim 17, wherein the image processing device changes the plurality of output pixel values of the display data by one of the plurality of equal values gradually every one or more than one frames in the plurality of frames.

19. The display device of claim 11, wherein the pixel values is a presentation manner of color gamut or a special format accepted by the display device.

20. The display system of claim 11, wherein the pixel values is a gray level or a chroma value.
